(19) United States
(12) Patent Application Publication
(10) Pub. No.: US 2003/0218010 A1
(43) Pub. Date: Nov. 27, 2003

(54) Cooker having a ceramic heating element for use in a microwave oven

(76) Inventors: Kyung Sun Jang, Suwon City (KR); Doo Yeol Chun, Seoul City (KR)

Correspondence Address: Squire, Sanders & Dempsey L.L.P., 801 S. Figueroa Street, 14th Floor, Los Angeles, CA, 90017-5554, US

(21) Appl. No.: 10/408,893

(22) Filed: Apr. 8, 2003

(30) Foreign Application Priority Data
May 24, 2002 (KR) 2002-0015998
May 30, 2002 (KR) 2002-0016610

(51) Int. Cl. H05B 6/80

(52) U.S. Cl. 219/730; 219/735

(57) ABSTRACT

This invention provides a cooking system capable of using microwave energy to heat food quickly and efficiently and form a crusty surface. The cooking system may include a base underneath a heating element that absorbs the microwave energy to generate thermal energy. The cooking system may also include a cover that covers a tray that is adapted to sit on top of the heating element. The cover may tightly close the tray that is adapted to hold food. The tray may be conductive to thermal energy so that the thermal energy from the heating element may be conducted to the tray to bake the side of the food that is on the tray.

### BACKGROUND OF THE INVENTION

1. Related Applications

This application claims priority to two Korean Patent Applications: (1) Korean Patent Application No. 2002-0015998, filed May 24, 2002, entitled COOKER HAVING A CERAMIC HEATING ELEMENT; and (2) Korean Patent Application No. 2002-0016610, filed May 30, 2002, entitled CERAMIC HEATING ELEMENT AND COOKER FOR USE IN MICROWAVE RANGE, which are both incorporated by reference.

2. Field of the Invention

This invention provides a cooking system capable of thermal heating food using a microwave oven to quickly cook the food without making the food soggy, and in particular, the cooking system may be adapted to cook a pizza.

3. General Background

Microwave ovens are popular because they cook food quickly. They are also efficient in their use of electricity because a microwave oven heats only the food rather than containers such as glass. A microwave oven uses microwaves to heat food. These are radio waves having frequency of about 2,500 megahertz (2.5 gigahertz). Radio waves in this frequency range are absorbed by water, fats, and sugars, and as they are absorbed they are converted into atomic motion causing heat. Microwaves in this frequency range have another interesting property: they are not absorbed by most plastics, glass, or ceramics. Metal reflects microwaves, which is why metal pans do not work well in a microwave oven.

When backing a cake using a conventional convection oven, the outside of the cake may burn before the inside even gets warm because the heat migrates, by conduction, from the outside of the food toward the middle. The air surrounding the food is hot and dry causing moisture within the food to evaporate, which forms a crispy, and brown surface while the inside is moist.

In microwave cooking, the radio waves penetrate the food and excite water and fat molecules where the friction between the molecules generates heat within the food. As such, there is no heat having to migrate toward the interior by conduction. Rather, heat is generated everywhere all at once because the molecules are all excited together. There are limits, of course. Radio waves penetrate unevenly in thick pieces of food so that molecules in the middle of the food may not be excited. Hot spots may also form where there is microwave interference. Unlike convection oven, however, air within the microwave oven is at room temperature so that the surface of the food does not get crusty or become brown. There are certain foods, however, where having a crusty surface is desirable, such as the bottom of a pizza. Therefore, there is a need for a cooking system that is capable of cooking food quickly and efficiently using microwave energy and forming a crusty surface.

### INVENTION SUMMARY

This invention provides a cooking system capable of using microwave energy to heat food quickly and efficiently and form a crusty surface. The cooking system may include a base underneath a heating element that absorbs the microwave energy to generate thermal energy. The cooking system may also include a cover that covers a tray that is adapted to sit on top of the heating element. The cover may tightly close the tray that is adapted to hold food. The tray may be conductive to thermal energy so that the thermal energy from the heating element may be conducted through the tray to bake the side of the food that is on the tray.

### BRIEF DESCRIPTION OF THE FIGURES

FIG. 1 is an expanded perspective view of a cooking system.

FIG. 2 is an assembled perspective view of a cooking system.

FIG. 3 is a cross-sectional view of a tray in the cooking system.

FIG. 4 is a perspective view of a heating element that is beaded.

FIG. 5 is a cross-sectional view of the cooking system to illustrate its operational functions.

### DETAILED DESCRIPTION OF THE INVENTION

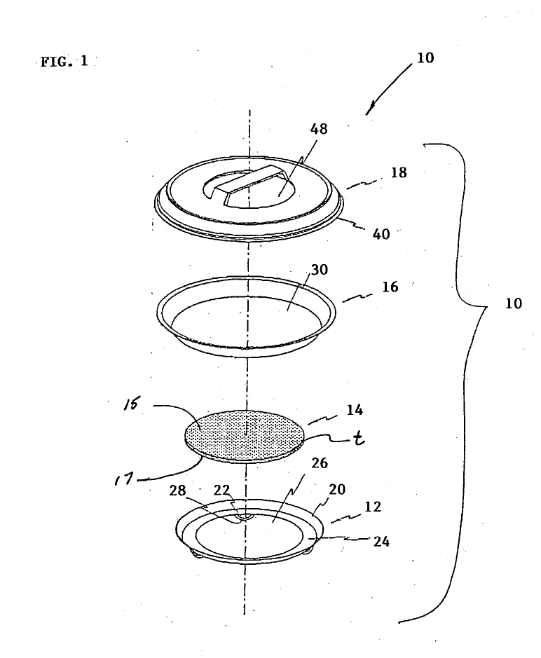

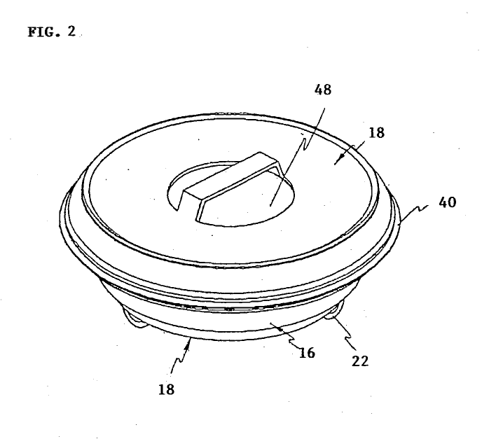

FIG. 1 illustrates a cooking system 10 capable of using microwave energy to heat food quickly and efficiently and form a crusty surface. The cooking system 10 includes a base 12 adapted to receive a heating element 14 that absorbs microwave energy and produces thermal energy. The cooking system 10 may also include a tray 16 so that the heating element 14 may be placed between the tray 16 and the base 12. The cooking system also includes a cover 18 that may be placed over the tray 16. The cover 18 may form a seal around the rim of the tray 16 that is adapted to receive a cooking object or food for heating. FIG. 2 illustrates an assembled cooking system 10 that may be placed into a microwave oven for cooking food. Once the microwave oven is turned on, the heating element 14 absorbs the microwave energy and generates thermal energy or heat that is conducted through the bottom of the tray 16 and heats up the food in the tray. As such, the food in the microwave may be cooked with a combination of thermal energy and microwave energy.

The base 12 may be adapted for microwave oven usage. The base 12 may include a plurality of legs 22 that projects from the frame 20 to provide a footing for the base 12. The base 12 may also include a rib 24 that has a circular or round-shape formed on the circumference of the frame 20 and recessed or adapted to receive the heating element 14. In this regard, the tray 16 may have a concaved shape bottom 30 adapted to receive cooking objects or items like pizza. A rib hole 26 may be formed within the base 24 so that the bottom side of the heating element 14 may absorb the microwave energy radiating from the microwave oven through the rib hole.

The legs 22 may be wrapped with an insulating cab 28 to protect the glass tray usually provided within microwave ovens. The insulating cab 28 may be made of silicon rubber material (Silicon). Accordingly, as the base 12 is placed on top of the heat-resisting glass resting on a turntable within the microwave oven, the cabs may prevent the cooking system from slipping as the heat-resisting glass turns. In a fully extend position, the legs 22 may have a certain height so that the distance between the heating element 14 and the heat-resisting glass is such that the heat from the heating element does not damage the heat-resisting glass.

The heating element 14 generates heat when it is subjected to microwave energy generated from the microwave range. The heating element may have a variety of shapes, such as a circular disk having a certain thickness, rectangular shape, diamond shape, or star shape. In particular, the circular disk shape as illustrated in FIG. 1 may have substantially flat upper and lower surfaces 15 and 17, respectively. The thickness “t” of the circular disk 14 may be between about ⅛ inches and about ¾ inches. The circular disk-heating element 13 may equally receive the microwave energy on the lower surface 17 to generate heat on the entire part of the heating element 14. The heat generated from the heating element 14 may then emit evenly through the upper surface 15 of the heating element 14. For additional heating capacity, a plurality of heating elements may be stacked on top of each other. For instance, another heating element may be placed on top of the heating element 14 to form a double stack of the heating elements.

The heating element 14 may be comprised of Al₂O₃, SiO₂, SiC, and MgO, and may also include clay and binder. For example, the heating element 14 may be comprised of the following elements by weight: Al₂O₃—about 10% to about 20%; SiO₂—about 20% to about 30%; SiC—about 20% to about 60%; MgO—about 1% to about 10%; Clay—about 1% to about 10%; and Binder—about 1% to about 10%.

The addition of Al₂O₃ and SiO₂ into the composition of the heating element 14 may be used to lower the intensity and the temperature of plasticity at the time of manufacturing the heating element 14. With regard to SiC, the temperature of plasticity may be ascended or descended by controlling the amount of SiC's content because SiC converts the microwave energy to heating-energy by absorbing microwaves. When more SiC's are used, the efficiency may increase as the temperature of plasticity rises, on the other hand, when the amount of SiC's is less, the efficiency may decrease as the temperature of plasticity drops. Put differently, the heating capacity of the heating element 14 may correspond to the amount of SiC's content used in the composition of the heating element and, therefore, the amount of SiC's content used may be predetermined to formulate a heating element 14 with a desirable heating capacity. The amount of SiC's used, however, may correlate to the manufacturing cost of the heating element so that heating capacity of the heating element 14 may need to be balanced with production cost. With regard to other elements, MgO, clay, and binder may be added at the time of manufacturing in order to efficiently operate the temperature of plasticity and formation.

The heating element 14 based on the composition discussed above may be manufactured in the temperature range of 1300˜1400° C. after the heating element is formed as a certain shape. A typical microwave oven may operate at about 2,500 megahertz. The heating element 14 may absorb microwave energy from such a microwave oven and generate the temperature range of about 200° C. to about 300° C.

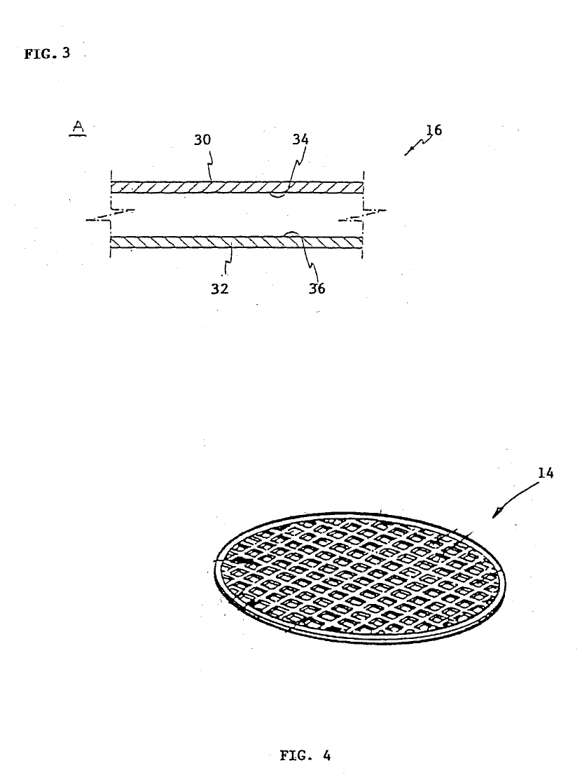

FIG. 3 illustrates a cross-sectional view of the tray 16 along the bottom where coating layers may be formed on the outer surfaces 30 and 32 and on the inner surfaces 34 and 36. The coating layers may provide non-stick, chemical resistance, and insulation with a predetermined amount of coating layers. The efficiency of insulation may be improved with the ceramic layer on the outer surfaces 30 and 32 of the tray 16. Moreover, the ceramic layer may also prevent the sparks from occurring within the microwave oven as the tray rotates. The ceramic layer may be formed and coated with organic chemical components, including SiO₂ line, and Al₂O₃ line ceramic, and organic/inorganic complex Hybrid paints manufactured by simultaneous Copolymerization of inorganic chemical components and organic chemical components including non-adhesive function. These inorganic chemical components may be consolidated in OH system by mutual condensation of Colloidal Solution, —(O—X—O—X—OH)-Group and OH-Group by repulsive power of static electricity—dispersed in water, and Silane chemical components. As such, the ceramic layer may have such characteristics as heat-resistance, high-solidity, and acid-resistance, like traditional ceramic materials, as well as the efficiency of non-stick that is the strength of fluorine materials.

FIG. 4 illustrates a heating element 14 that may be adapted to conduct heat more evenly. The heating element 14 may be beaded to form a waffle like configuration. In this regard U.S. Pat. No. 4,927,991 issued to Wendt et al. is incorporated by reference into this application. This way, the heating element placed about the middle part of the tray 16 may more evenly transfer heat to the bottom of the tray 16.

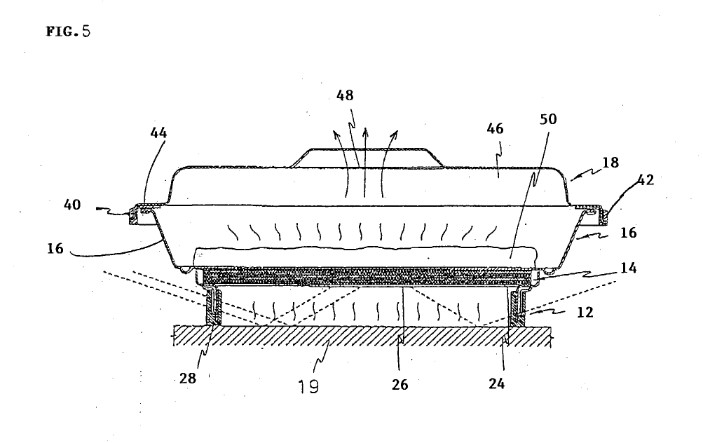

FIGS. 1, 2, and 5 illustrate the cover 18 having a lip 40 that may flange down or form on the edge of the lower part of the cover 18. The lip 40 may be provided with insulating materials 42 along the outer surface area of the lip 40 to substantially prevent sparks from occurring as the cover touches the inner surface of the microwave oven as the cooking system 10 rotates. A variety of insulating materials may be used such as silicon rubber. As further illustrated in FIG. 5, insulating material 44 may be provided in the inner surface of the cover 18 around the lip 40 so that once the cover 18 is placed over the tray 16, a seal may be formed between the lip 40, and the tray 16, then a space 46 is formed between the cover 18 and the tray 16. Besides the insulating material, the coating layer 30 may also prevent the sparks from occurring within the microwave oven.

The cover 18 may also have a hole 48 with a predetermined diameter that allows certain amount of moisture and heat within the space 46 to exhaust through the hole 48, while cooking the food 50. The size of the hole may determine the amount of moisture and heat that may exhaust through the hole 48. The hole 48 may be formed in the center of the cover 18 so that microwave energy may enter the space 46 through the hole 48, but substantially blocked along the outer perimeter portion of the cover 18. The size of the hole 48 may be varied through an apparatus such as a fan or sliding cover that may be formed on the interior side of the cover 18, or any other method known to one skilled in the art.

The cover 18 may substantially prevent certain portions of the food such as the outer crust area of a pizza from directly being exposed to the microwave that may dry the crust. The cover may also insulate or block the heat in the outer perimeter of the cover to enhance the thermal effect to efficiently cook the food. With the hole 48 about the center of the tray 18, moisture is able to escape so that the food does not become soggy around the center, and may be exposed to more microwave energy to cook more along the center. For example, when heating or cooking a pizza using a microwave oven, one of the problems is that the middle of the pizza may be soggy and the crust of the pizza may be dry. With the cooking system 10 such a problem may be minimized because the hole 48 allows the moisture to escape so that the middle of the pizza does not become soggy. The crust of the pizza may also not become dry because the cover 18 insulates the moisture within the space 46 around the crust of the pizza.

FIG. 5 illustrates one of many ways to assemble the cooking system 10. The heating element 14 may be placed on top of the rib 24 of the base 12. Then, the tray 16 may be placed on the upper part of the frame 20, and food may be placed into the tray 16. The cover 18 may be placed over the tray 16 to enclose the food. The cooking system may be then placed into a microwave oven for heating or cooking. In most instances, the cooking system 10 may be placed onto a glass table that turns once the microwave oven is turned on. As the microwave oven radiates microwave energy in all directions within the oven, at least a portion of the microwave energy may reflect off the bottom side 19 of the microwave oven towards the heating element 14 through the rib hole 26 of the base 12, and other portion of the microwave energy may radiate directly to the cover 18. The heating element 14 may then convert the microwave energy to thermal energy that may generate temperatures in the range of about 200° C. to 300° C. The thermal energy may be then conducted to the tray to cook the food via thermal energy so that when cooking a pizza, the bottom of the pizza may be crusty rather than soggy.

The moisture that is developed in the space 46 near the hole 48 may evaporate through the hole 48. The amount of evaporation may be controlled through varying the size of the hole 48 so that the appropriate level of humidity may be maintained within the space 46 to prevent the food such as a pizza from burning. Microwave energy that is radiated onto the cover 18 may be blocked to substantially prevent the food in certain areas, such as along the perimeter of the cover 18, from being overcooked or burned.

As described above, the cooker for use in microwave range can efficiently cook the object, properly placed in a microwave, by using the heat generated from the Heating

What is claimed is:

1. A cooking system capable of using microwave energy to heat food, comprising:
a base adapted to sit on top of a counter within a microwave oven;
a tray adapted to hold food;
a heating element between the base and the tray, where the heating element is adapted to convert microwave energy to thermal energy; and
a cover having a hole adapted to at least partially enclose the tray forming a space between the cover and the tray, where the hole allows moisture formed within the space to escape through the hole so that the food in the tray does not get soggy.

2. The cooking system according to claim 1, where the heating element is made of composition including:
about 10% to about 20% by weight of Al₂O₃;
about 20% to about 30% by weight of SiO₂; and
about 20% to about 60% by weight of SiC.

3 The cooking system according to claim 2, where the heating element has a circular disk shape.

4. The cooking system according to claim 3, where the circular disk has substantially flat upper and lower surfaces.

5. The cooking system according to claim 1, further including:
a plurality of legs adapted to project from the base to provide a footing for the base at a predetermined distance from the counter of the microwave oven.

6. The cooking system according to claim 1, where the base has a rib hole that allows a bottom side of the heating element to absorb the microwave energy through the rib hole.

7. The cooking system according to claim 1, where the hole on the cover is adjustable to control humidity between the cover and the tray.

8. The cooking system according to claim 1, where the tray has a coating of ceramic layer.

9. The cooking system according to claim 8, where the ceramic layer includes:
SiO₂ line and Al₂O₃ line ceramic; and
an inorganic chemical compound including consolidated in OH system by mutual condensation of colloidal solution.

10. The cooking system according to claim 1, where the heating element is beaded to evenly conduct heat to the tray.

11. The cooking system according to claim 1, where the cover has a lip, where the lip is insulated.

12. The cooking system according to claim 1, where the tray is adapted to hold a pizza.

13. A heating element capable of absorbing microwave energy to thermal energy, comprising:
about 10% to about 20% by weight of Al₂O₃;
about 20% to about 30% by weight of SiO₂; and
about 20% to about 60% by weight of SiC.

14. The heating element according to claim 13, further including:
about 1% to about 10% by weight of MgO.

15. The heating element according to claim 13, further including:
about 1% to about 10% by weight of clay; and
about 1 wt % to about 10% by weight of binder.

16. The heating element according to claim 13, where increasing the amount of SiC to increase the heating capacity of the heating element.

17. The heating element according to claim 13, where the heating element has a circular disk shape.

18. A cooking system for microwave oven use, comprising:
a heating element having about 20% to about 60% by weight of SiC to absorb microwave energy and generate heat;
a base having a rib adapted to receive the heating element, where the rib forms a rib hole that allows microwave energy to travel through the rib hole and towards the heating element;
a tray having a bottom that is adapted to receive food, where the heating element is between the bottom of the tray, and the base; and
a cover adapted to at least partially enclose the tray to at least partially insulate the food in the tray from direct microwave energy.

19. The cooking system according to claim 1, where the heating element is made of composition including:
about 10% to about 20% by weight of Al₂O₃; and
about 20% to about 30% by weight of SiO₂.

20. The cooking system according to claim 18, where the base has a rib hole that allows a bottom side of the heating element to absorb the microwave energy through the rib hole.

21. The cooking system according to claim 18, where the cover has a hole that is adjustable to control the humidity between the cover and the tray.

22. The cooking system according to claim 18, where the heating element is beaded to evenly conduct heat to the tray.

23. The cooking system according to claim 18, where the cover has a lip, where the lip is insulated.

24. A method for converting microwave energy to thermal energy to heat food, comprising:
supporting a food having a bottom side and a top side;
converting microwave energy to thermal energy;
conducting the thermal energy to the bottom side of the food; and
controlling the humidity along the top side of the food.

25. The method according to claim 24, where the step of converting is a heating element comprised of:
about 10% to about 20% by weight of Al₂O₃;
about 20% to about 30% by weight of SiO₂; and
about 20% to about 60% by weight of SiC.

26. The method according to claim 25, further including:
increasing the SiC content in the heating element to increase the heating capacity of the heating element.

27. The method according to claim 24, further including:
blocking a predetermined area along the top side of the food from microwave energy to minimize the top side of the food from burning.

28. The method according to claim 24, further including:
insulating the supporting with a ceramic layer.

29. The method according to claim 25, further including:
stacking another heating element on top of the heating element to form a double stack of the heating elements.

30. A cooking system for microwave oven use, comprising:
means for supporting a food having a top side and a bottom side;
means for converting microwave energy to thermal energy;
means for transferring the thermal energy to the bottom side of the food; and
means for insulating the top side of the food from microwave energy to minimize the top side from burning.
